(19) United States
(12) Patent Application Publication
(10) Pub. No.: US 2005/0280380 A1
(43) Pub. Date: Dec. 22, 2005

(54) Multivibrator circuit for pulse width modulation

(76) Inventor: Guenter Lohr, Leinfelden-Echterdingen (DE)

Correspondence Address: STRIKER, STRIKER & STENBY, 103 EAST NECK ROAD, HUNTINGTON, NY, 11743, US

(21) Appl. No.: 11/142,098

(22) Filed: Jun. 1, 2005

(30) Foreign Application Priority Data
Jun. 2, 2004 (DE) 10 2004 026 846.0

(51) Int. Cl. H02P 5/00

(52) U.S. Cl. 318/139

(57) ABSTRACT

A multivibrator circuit has one series circuit including a first resistance and a first capacitor and determining a first switching time, and another series circuit including a second resistance and a second capacitor and determining a second switching time, a potentiometer having an arm that establishes a first resistance subregion and a second resistance subregion of the potentiometer, wherein the first resistant subregion constitutes the first resistance and the second resistant subregion constitutes the second resistance; also there are provided an electric hand tool having an electric motor and the multivibration circuit that influences a delivery of power to the electric motor, a use of a multivibrator circuit for generating a pulse width modulated signal for triggering an electric motor of an electric hand tool, and a method for variably adjusting a first and a second switching time of the multivibrator circuit.

### BACKGROUND OF THE INVENTION

The present invention relates to a multivibrator having a series circuit, which is comprised of a first resistance and a first capacitor and determines a first switching time, and having a series circuit, which is comprised of a second resistance and a second capacitor and determines a second switching time.

The present invention also relates to an electric hand tool, a use of a multivibrator circuit, and a method for variably adjusting a first and second switching time of a multivibrator circuit.

Multivibrator circuits of this type are known. A circuit of this kind is known, for example, from the textbook Semiconductor Circuit Technology [Halbleiter-Schaltungstechnik], by U. Tietze and Ch. Shenk, 9^{th} edition, Springer Verlag Berlin, Chapter 8.2.3, pp. 173-174. It is characteristic for the multivibrator circuit to continuously switch back and forth between two states once it has been struck. In the known multivibrator circuit, however, it is disadvantageous that the switching times are established with the dimensioning of the circuit and cannot subsequently be changed.

### SUMMARY OF THE INVENTION

Accordingly, it is an object of the present invention to provide a multivibrator circuit which eliminates the disadvantages of the prior art.

In keeping with these objects and with others which will become apparent hereinafter, one feature of the present invention resides, briefly stated, in a multivibrator circuit, comprising one series circuit including a first resistance and a first capacitor and determining a first switching time, and another series circuit including a second resistance and a second capacitor and determining a second switching time; a potentiometer having an arm that establishes a first resistance subregion and a second resistance subregion of said potentiometer, wherein said first resistant subregion constitutes said first resistance and said second resistant subregion constitutes said second resistance.

According to the present invention, a potentiometer with an arm is positioned in the multivibrator circuit. The arm establishes a first resistance subregion and a second resistance subregion of the potentiometer; the first resistance subregion of the potentiometer constitutes the first resistance and the second resistance subregion constitutes the second resistance. With the proposed circuit, it is now possible to change the switching times even after construction of the circuit and in particular, during operation.

The relation:
t1≈R2·C1·In2
yields the first switching time of a multivibrator circuit and the relation:
t2≈R2·C2·In2
yields the second switching time of a multivibrator circuit, where the variables represent the first resistance (R1), the first capacitor (C1), the second resistance (R2), and the second capacitor(C2). It is clear from the equations that—with capacitance values of the capacitors that are assumed to be essentially constant—an increase in a resistance value results in a proportional change in the respective switching time. This means that a reduction of the resistance results in a reduction of the switching time and an increase in the resistance results in an increase in the switching time. It is therefore easy to change the switching times of the multivibrator circuit.

The basic design of a potentiometer results in an interdependence between the resistance values of the first resistance subregion and the second resistance subregion, namely such that an increase in the resistance value of the first resistance subregion produced by a movement of the arm directly results in a reduction in the resistance value of the second resistance subregion. Likewise, a reduction of the resistance value of the first resistance subregion results in an increase in the resistance value of the second resistance subregion. It is generally clear that a resistance change in one resistance subregion produces an opposite resistance change in the other resistance subregion. Based on the preceding explanations, it therefore follows that the arm position of the potentiometer has a direct effect on the switching times t1 and t2; an increase in the one switching time results in a reduction in the other switching time and vice versa.

It is thus possible to simply and quickly vary the ratio between the first and second switching time (pulse duty factor) and, with an appropriate dimensioning of the components, it is possible to establish a wide range of potential pulse duty factors. In addition, suitably selected component dimensions make it possible to achieve particular effects in the multivibrator circuit. It is thus possible, for example, when using a linear potentiometer and two capacitors with the same capacitance values, for the individual switching times to be variable whereas the sum of the switching times remains essentially constant.

The first resistance advantageously has a third resistance series connected after the first resistance subregion and/or the second resistance has a fourth resistance series connected after the second resistance subregion. This permits a particular, constant resistance portion to be added to the first resistance and/or the second resistance.

In an advantageous embodiment, the first resistance and the second resistance have a fifth resistance series connected before the potentiometer. This influences the first resistance and the second resistance uniformly by means of an additional resistance value.

In an advantageous modification of the present invention, the multivibrator circuit has at least two switching elements whose switching states determine the operating state of the multivibrator circuit; a first cross-coupling line between the second resistance and a control connection of a first switching element has a first diode and/or a second cross-coupling line between the first resistance and a control connection of a second switching element has a second diode.

It is advantageous if the first switching element is embodied in the form of a first transistor, the second switching element is embodied in the form of a second transistor, and the respective control connection is the base of the respective transistor. As a result, it is possible for the circuit to be manufactured in a particularly inexpensive manner and for it to also be operated with voltages greater than 10 V due to the presence of the above-mentioned diodes.

The multivibrator circuit is advantageously associated with a low-impedance output stage embodied in the form of a double-transistor arrangement. This permits the proposed circuit to be very inexpensively designed for low currents and voltages since only a low-energy signal is generated. The output stage is able to supply this signal for example to the gate of a power transistor; a higher power, for example of the kind required to operate an electric motor, then need only be supplied via the power transistor.

The present invention also relates to an electric hand tool, in particular a battery-powered electric hand tool with an electric motor. In this connection, it is known to trigger the electric motor by means of a pulse width modulation circuit in order to control or regulate the speed or torque of the electric hand tool, or—as it is generally called—the delivery of power to the electric motor. Usually dual operation amplifier circuits or circuits with a timer component are used as the pulse width modulation circuit. But circuits of this kind are relatively expensive. According to the present invention, the delivery of power to the electric motor is influenced by means of a multivibrator circuit of the type described above. An electric hand tool of this kind can be produced inexpensively. It is also possible to connect the induction regulator of the potentiometer directly or indirectly to a control that is accessible to the operator of the electric hand tool so that the operating state of the tool that the user sets by means of the control acts on the multivibrator circuit in a simple way.

The present invention also relates to the use of a multivibrator circuit, particularly of an above-mentioned multivibrator circuit, to generate a pulse width modulated signal for triggering an electric motor of an electric hand tool. Since the output of the multivibrator circuit has two levels, which can correspond to the two levels of a pulse width modulated square wave signal, and it is possible to set the pulse duty factor between the two levels, it is advantageously possible to use the multivibrator circuit to trigger an electric motor of an electric hand tool. It is therefore basically possible to supply the power produced for the electric motor directly via the multivibrator circuit or to use the multivibrator circuit as a signal emitter, which controls a power transistor that conveys the power to the electric motor. Usually, the latter alternative is preferable for practical and cost-related reasons.

Finally, the present invention also relates to a method for variably setting a first and second switching time of a multivibrator circuit, in particular of an above-mentioned multivibrator circuit, having a series circuit, which is comprised of a first resistance and a first capacitor and determines the first switching time, and having a series circuit, which is comprised of a second resistance and a second capacitor and determines the second switching time; the first and second resistances are variably set as a function of the desired operating state. An increase of the first or second resistance directly results in a reduction of the respective other resistance, while a reduction of the first or second resistance directly results in an increase of the respective other resistance.

In a pulse width modulated signal, the fundamental frequency usually remains essentially constant, even when there are changes in the pulse duty factor. With the method according to the present invention, this is achieved in a simple way in that an increase of the first or second resistance and therefore of the first or second switching time directly results in a reduction of the respective other resistance and therefore of the respective other switching time. An appropriate dimensioning of the components that determine the parameters of the method results in the fact that when the pulse duty factor is changed, the sum of the switching times—analogous to the fundamental frequency—remains essentially constant or at least moves within a defined bandwidth.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a multivibrator circuit in accordance with the present invention, and

FIG. 2 shows an electric hand tool in accordance with the present invention.

### DESCRIPTION OF THE PREFERRED EMBODIMENTS

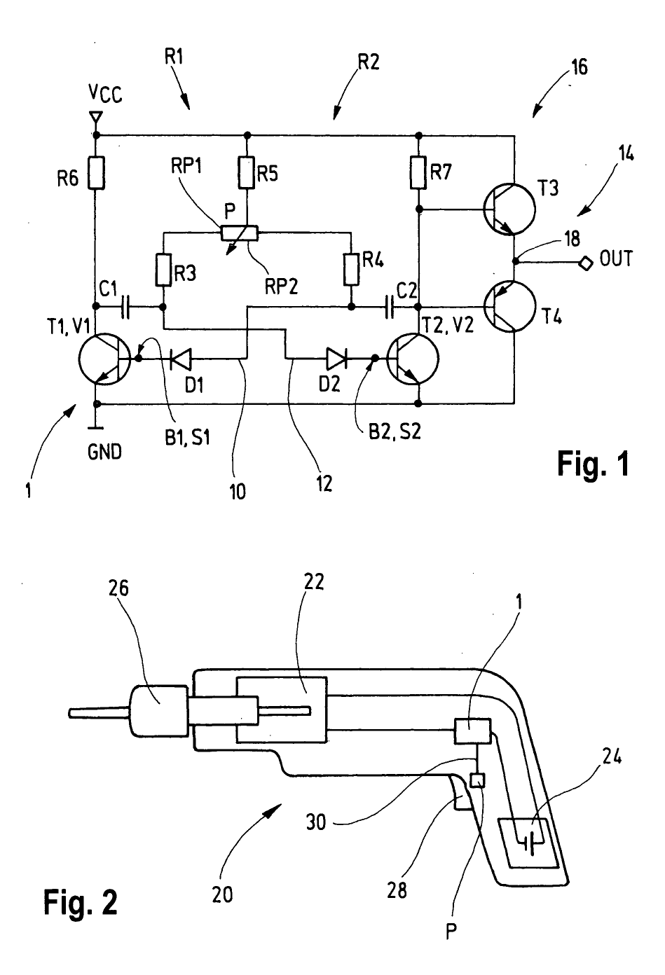

FIG. 1 shows a multivibrator circuit 1 that has the following basic elements, whose functional association is known from the prior art and need not be described in detail: a first resistance R1, a second resistance R2, a first capacitor C1, a second capacitor C2, a first switching element V1—a transistor T1 in this case, a first switching element V2—a transistor T2 in this case, a first cross-coupling line 10, a second cross-coupling line 12, and the resistances R6 and R7. As is clear from the drawing, the multivibrator circuit 1 is connected to a supply voltage VCC and a ground potential GND.

Whereas in a known multivibrator circuit, the first resistance R1 and second resistance R2 are as a rule each embodied in the form of a discrete component, the resistances mentioned here are comprised of combinations of several elements; the arm of the potentiometer P establishes a first resistance subregion RP1 and a second resistance subregion RP2:
R1=2·R5+RP1 +R3
R2 =2·R5+RP2+R4

This yields the switching times:
t1≈(2·R5+RP1+R3)·C1·In2
t2≈(2·R5+RP2+R4)·C2·In2

It is thus clear that the first switching time t1 and the second switching time t2 are dependent on the value of the resistance subregions RP1, RP2 established by the arm position of the potentiometer P. The resistance subregions RP1, RP2 are interdependent such that a change in the value of one resistance subregion RP1, RP2 produces an opposite change in the resistance value of the other resistance subregion RP1, RP2. For the switching times t1, t2, this means that the reduction of the one switching time t1, t2 results in an increase in the other switching time t1, t2 and vice versa.

It should be noted that the first cross-coupling line 10 has a first diode D1 and the second cross-coupling line 12 has a second diode D2. It is thus also possible to operate the multivibrator circuit 1 using supply voltages VCC greater than 10 V.

In the multivibrator circuit 1 shown, the collector/emitter voltage of the second transistor T2 is not picked up directly. Instead, a low-impedance output stage 16 embodied in the form of a double-transistor arrangement 14 is provided here, which has an npn transistor T3 and a pnp transistor T4; the emitters of these transistors are connected to the node 18. The signal output OUT leads from the node 18 and enables the signal generated by the multivibrator circuit 1 to be processed. For example, the output signal can be conveyed to the gate of a power transistor that is not shown, the power transistor being series connected to an electric motor, thus controlling the delivery of power to the electric motor based on the pulse width modulated signal at the gate. It is possible to set pulse duty factors of between 0 and 100%, depending on the dimensioning of the components, in particular of the resistances R3, R4, and R5. However, it is likewise possible to intentionally limit the range of possible pulse duty factors, for example to a range between 5% and 40%.

FIG. 2 shows an electric hand tool 20 with an electric motor 22, which is powered by a battery 24 and drives a tool spindle 26. The operator uses the control 28 to adjust the delivery of power to the electric motor 22. A toothed rack—not shown—transmits an actuation of the control 28 to an arm of the potentiometer P so that the actuation of the control 28 produces a change in the arm position of the potentiometer P. The connecting line 30 indicates that the potentiometer P, as depicted in FIG. 1, is functionally integrated into a multivibrator circuit 1.

In this exemplary embodiment, the multivibrator circuit 1 also has a power transistor—not shown—that is controlled by means of a pulse width modulated signal generated by the multivibrator circuit 1 and controls the amount of power that the battery 24 delivers to the electric motor 22. The user is thus able to set a desired speed or a desired torque of the electric hand tool 20.

It will be understood that each of the elements described above, or two or more together, may also find a useful application in other types of constructions differing from the types described above.

While the invention has been illustrated and described as embodied in multivibrator circuit for pulse width modulation, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A multivibrator circuit, comprising one series circuit including a first resistance and a first capacitor and determining a first switching time, and another series circuit including a second resistance and a second capacitor and determining a second switching time; a potentiometer having an arm that establishes a first resistance subregion and a second resistance subregion of said potentiometer, wherein said first resistant subregion constitutes said first resistance and said second resistant subregion constitutes said second resistance.

2. A multivibrator circuit as defined in claim 1, wherein said first resistance has a third resistance series connected after said first resistant subregion.

3. A multivibrator as defined in claim 1, wherein said second resistance has a fourth resistance series connected after said second resistance subregion.

4. A multivibrator as defined in claim 1, wherein said second resistance has a third resistance series connected after said first resistance subregion, and said second resistance has a fourth resistance series connected after said second resistance subregion.

5. A multivibrator as defined in claim 1, wherein said first resistance and said second resistance have a fifth resistance series connected before said potentiometer.

6. A multivibrator as defined in claim 1; and further comprising at least two switching elements whose switching states determine an operating state of the multivibration circuit; and a cross-coupling line having a diode between one of said second resistances and a control connection another one of said switching elements.

7. A multivibrator as defined in claim 1; and further comprising at least two switching elements whose switching state determine an operating state of the multivibrator circuit; a first cross-coupling line having a first diode between said second resistance and a control connection of a first one of said switching elements; and a second cross-coupling line having a second diode between said first resistance and a control connection of second one of said switching elements.

8. A multivibrator as defined in claim 7, wherein said first switching element is formed as a first transistor, said second switching element being formed as a second transistor, and one of said control connections being a base of a respective one of said transistors.

9. A multivibrator as defined in claim 1; and further comprising a low-impedance output stage associated with the multivibrator circuit and formed as a double transistor arrangement.

10. An electric hand tool, comprising an electric motor; and a multivibrator circuit which influences a delivery of power to said electric motor, said multivibration circuit having one series circuit including a first resistance and a first capacitor and determining a first switching time, and another series circuit including a second resistance and a second capacitor and determining a second switching time, and a potentiometer having an arm that establishes a first resistance subregion and a second resistance subregion of said potentiometer, wherein said first resistant subregion constitutes said first resistance and said second resistant subregion constitutes said second resistance.

11. An electric hand tool as defined in claim 10, wherein the electric tool is a battery-powered electric hand tool.

12. A method of generating a pulse width modulated signal for triggering an electric motor of an electric hand tool, comprising the steps of using a multivibration circuit having one series circuit including a first resistance and a first capacitor and determining a first switching time, and another series circuit including a second resistance and a second capacitor and determining a second switching time, and a potentiometer having an arm that establishes a first resistance subregion and a second resistance subregion of said potentiometer, wherein said first resistant subregion constitutes said first resistance and said second resistant subregion constitutes said second resistance.

13. A method of variably adjusting a first and second switching time of a multivibration circuit having a series circuit including a first resistance and a first capacitor and determining a first switching time and also a series circuit including a second resistance and a second capacitor and determining a second switching time; variably adjusting the first and second resistance as a function of a desired operating state; providing an increase in the first or second resistance directly resulting in a reduction in a respective other resistance and providing a reduction in the first or second resistance directly resulting in an increase in the respective other resistance.
